(19) United States
(12) Patent Application Publication
(10) Pub. No.: US 2002/0014603 A1
(43) Pub. Date: Feb. 7, 2002

(54) Radiation detector using a doped crystal

(76) Inventor: Lev Nagli, Petach-Tikva (IL)

Correspondence Address: William Dippert, c/o Cowan, Liebowitz and Latman, 1133 Avenue of the Americas, New York, NY, 10036-6799, US

(21) Appl. No.: 09/788,318

(22) Filed: Feb. 16, 2001

Related U.S. Application Data
(63) Continuation-in-part of application No. PCT/IL98/00388, filed on Aug. 17, 1998.
Application No. PCT/IL98/00388 is a continuation-in-part of application No. 08/726,340, filed on Oct. 3, 1996, now Pat. No. 5,796,113.
(60) Provisional application No. 60/004,858, filed on Oct. 5, 1995.

(51) Int. Cl. G01T 1/16

(52) U.S. Cl. 250/581

(57) ABSTRACT

A radiation detector for use in imaging with ionizing radiation, comprising a crystal having a surface area and a thickness wherein the doping profile in a thickness direction of the crystal has the form αM, where M is the dopant and α varies with the thickness direction.

### RELATED APPLICATIONS

This application is a continuation-in-part of PCT Application No. PCT/IL98/00388, filed on Aug. 17, 1998 which is a continuation-in-part of U.S. Pat. application Ser. No. 08/726,340 filed on Oct. 3, 1996, now U.S. Pat. No. 5,796,113, and also claims the benefit under §119(e) of U.S. Provisional Application No. 60/004,858 filed on Oct. 5, 1995. The disclosures of all of these applications are incorporated herein by reference.

### FIELD OF THE INVENTION

The invention relates to detecting ionizing radiation in general and to crystal or polycrystalline photostimulatable detectors in particular.

### BACKGROUND OF THE INVENTION

Detectors utilized in the art of acquisition and reproduction of ionizing radiation images are well known in the art. The images stored in these detectors are read out by stimulating the crystals to radiate. This radiation reproduces the stored image. A detector that may be stimulated to radiate is called a stimulatable detector. When such a stimulatable detector is irradiated with ionizing radiation carrying a pattern (e.g. X-rays who passed through a human body), electron-hole pairs are created whose distribution depends on the pattern carried by the radiation. Reading out the stored pattern is performed by stimulating the detector with a light (photo-stimulation) at a suitable wave length or alternatively, by heating the detector (thermo-stimulation). The stimulated crystal emits light which reproduces the stored pattern. Typically, the stimulating light is red or infra-red while the emitted light is visible in the violet-green spectral range.

Description of such stimulatable phosphors as well as apparatus and methods concerning their photo-stimulation mechanisms are to be found in U.S. Pat. Nos. 4,239,968, 4,261,854, 5,028,509, 5,180,610, 5,227,097, 5,360,697 and papers: “Luminescent Alkali Halide Crystal Memory Elements” by I. K. Plyavin, V. P. Objedkov, G. K. Vale, R. A. Kalnin and L. E. Nagli in Luminescence of Crystals, Molecules and Solutions, The proceedings of the International Conference on Luminescence, Leningrad USSR, August 1972, edited by Fred Williams, Published by Plenum Press, New York, 1973 and “Photostimulation mechanisms of X-ray irradiated RbBr:Tl” by H. Von Seggem, A. Meijernik, T. Vogt and A. Winacker in Journal of Applied Physics Vol. 66, pp. 4418-4424 (1989) which are herein incorporated by reference.

Detectors utilized in the art may be polycrystalline or single crystals, which are substantially transparent to stimulating and/or fluorescent light and substantially permeable to the pattern carrying radiation. For convenience, the term “crystalline” will be used to denote both single and polycrystalline materials. These crystals may have structural defects and/or non controlled impurities which scatter the stimulating and/or the emitted light. As a consequence, the spatial resolution and/or the sensitivity of the final image may be poor. Activated alkali-halide crystallines such as RbBr:Tl, KBr:In, KI:Tl, etc., Europium or Cerium activated Barium Fluoro-halides such as BaFBr:Eu and/or Silver activated Zinc Sulfide are some examples of crystallines utilized in radiography. Ideally, these crystallines must have a high absorption coefficient for the ionizing radiation and must be transparent to stimulating and fluorescence light; in practice they only represent a compromise between these parameters.

The crystalline thickness provides a trade off between the sensitivity of the crystalline to the radiation and the spatial resolution attained in the final image. If the absorption coefficient of the crystalline for the ionizing radiation is low, the radiation penetrates further into the crystalline material before the radiation creates electron-hole pairs. Thus, a thicker crystalline material is required to achieve a high sensitivity. However, if the a thick crystalline detector is used, the distance the fluorescence light has to propagate to exit the crystalline material is long, the light spreads out to a larger surface and the spatial resolution in the final image is low. Conversely, if the crystalline detector is thick, stimulation light propagates a larger distance inside the material. The longer the distance the stimulation light propagates inside the material the larger the number of electron-hole pairs it encounters; the larger the amount of recombination the light provokes; and the higher the intensity in the final image.

Three different methods of producing the photo-stimulatable, pattern storage crystalline materials for use with ionizing radiation are known in the art: a) growing a crystal in melt from a mixture of alkali-halide and dopant; b) pressing a doped polycrystalline powder in a press to form a transparent polycrystalline detector; and c) providing a doped crystal, in polycrystalline form on a substrate such as paper, glass or sapphire. In order to be effective, the materials produced by methods a) and b) should be substantially transparent. However, due to scatter and thickness effects, detectors produced by these methods produce images with relatively poor resolution.

### SUMMARY OF THE INVENTION

According to one aspect of some preferred embodiments of the present invention a substantially transparent imaging crystalline material is provided in which a thin layer is highly doped. In a preferred embodiment of the invention, the remainder of the crystalline material is not doped. Alternatively, the remainder of the crystalline material may be lightly or heavily doped compared to the thin layer.

In a preferred embodiment of the invention the imaging crystal has the general formula

X:αM

where X is a crystalline base material, M is a dopant preferably, Tl⁺, In⁺, Ga⁺ Ag⁺ or Cu⁺ or others such as those known in prior art and α represents the concentration of the activator which is preferably kept between 0.1 and 1 m% (approximately 10¹⁸−10¹⁹ ions/cm³). In one especially preferred embodiment of the invention, X is a crystal or polycrystalline material of the form AⁱB^{vii} where Aⁱ is an alkaline metal preferably Li, Na, K, Rb, or Cs and B^{vii} is a halogen preferably, F, Br, Cl or I. Alternative base materials are BaFlY, where Y is Cl, Br, or I (generally available only as a transparent polycrystalline material), WO₂ (generally has a low sensitivity), BaF or CaF (available in both grown crystal and pressed polycrystalline forms, with low sensitivity).

The dopant is preferably present only in the thin layer. In preferred embodiments of the invention, the layer is between 1 and 1000 micrometers thick. Optionally, the layer is between 150 and 400 micrometers thick. Alternatively, the layer is between 1 and 150 micrometers.

In a preferred embodiment of the invention the dopant is diffused into an undoped crystalline material or a crystalline material having a low doping.

According to a second aspect of some preferred embodiments of the invention, a focused laser beam is used to read a thin layer of doped photostimulatable material present in a crystal. Since all (or very nearly all) the photostimulatable material is present in a thin layer, the beam may be focused on the layer. Furthermore, since the crystalline material is preferably substantially transparent to both the stimulating and stimulated radiation, the achievable resolution is very high. Thus, if a scanning laser beam is used to read thick crystals or polycrystalline layers as in the prior art crystals the best achievable resolution is several line pairs per mm. For such scanning in the present invention, resolution of several 10 s of microns or 20 line pairs per mm are achievable.

According to a further aspect of some preferred embodiments of the invention, the thin layer is photostimulated all at once and an image is taken of the layer. Here again, the present invention provides for much improved resolution over that achievable in the prior art.

In a further aspect of some preferred embodiments of the invention a thin, highly doped layer thin layer is formed on a much thicker lightly doped crystalline material. In preferred embodiments of the invention, the dopant used in the thin layer is different from that used in bulk crystalline material used as the base. Preferably, dopants are used which provide different wavelengths of stimulated emission from the thin layer and from the bulk material. If images of the different wavelength images are separately acquired, it is possible to acquire both a high resolution image and a high sensitivity image from the same dosage of X-ray. Viewing both images may provide additional diagnostic insights.

Preferably, for all embodiments of the invention, the crystalline material has high absorption coefficient for ionizing radiation while maintaining high transparency for stimulating and fluorescence light. It is the combination of overall efficiency of light production from x-ray and transparency that determines the choice of crystalline material to be used.

There is thus provided, in accordance with a preferred embodiment of the invention, a radiation detector for use in imaging with ionizing radiation, comprising a crystalline material having a surface area and a thickness wherein the doping profile in a thickness direction of the crystalline material has the form αM, where M is the dopant and α varies with the thickness direction.

In a preferred embodiment of the invention, the crystalline material has the general formula:

AⁱB^{vii}:αM

where Aⁱ is an alkaline metal, B^{vii} is a halogen, preferably chosen from the group consisting of fluorine, bromine, chlorine and iodine.

Preferably, the alkali metal is chosen from the group consisting of lithium, sodium, potassium, rubidium, and cesium.

In another preferred embodiment of the invention the crystalline material has the form:

BaFY:αM,

wherein Y is chosen from the group comprising Cl, Br and I.

In another preferred embodiment of the invention, the crystalline material has the form BaF:αM. In another preferred embodiment of the invention the crystalline material is CaF:αM.

Preferably, the dopant comprises a dopant chosen from the group consisting of Tl⁺, In⁺, Ga⁺, Ag⁺, Cu⁺, Sn⁺⁺, Pb⁺⁺, or Eu⁺⁺.

In an especially preferred embodiment of the invention, the spatially varying component of dopant is concentrated near the surface area. Preferably, the concentration of the spatially varying component of the dopant concentration falls to half the its value at the surface within a distance having a range of 1 to 1000 micrometers. Optionally, the distance is between 150 and 400 micrometers. More preferably the distance is between 200 and 300 micrometers. Alternatively, the distance is between 1 and 150 micrometers.

In a preferred embodiment of the invention, a spatially varying component of α has a maximum value in a range from 0.1 to 3 m%. Preferably, α is less that 2 m% or less than 1 m%.

In one preferred embodiment of the invention, α has a substantial, non-zero value throughout the crystal. Preferably, the ratio of the value of α at the surface of the crystal and within its bulk is greater than or equal to about 2.

In a preferred embodiment of the invention, the crystalline material is a single crystal material. Alternatively, the crystalline material is polycrystalline.

In a preferred embodiment of the invention, the crystal is substantially uniformly doped with a photo-stimulatable dopant different from that having a concentration varying with the thickness direction. Preferably, the various dopant materials emit light of different wavelengths when photostimulated.

There is further provided, in accordance with a preferred embodiment of the invention, a method for producing a crystalline material comprising:

a) providing a crystalline material;

b) contacting a first face of the crystalline material with a photo-stimulatable dopant; and

c) heating the crystalline material and the dopant at a given temperature for a time sufficient to produce a desired non-uniform dopant profile in the crystal.

There is further provided, in accordance with a preferred embodiment of the invention, a method for producing a crystalline material comprising:

a) providing a crystalline material; and

b) implanting a photo-stimulatable dopant into a surface of the crystalline material by ion implantation.

There is further provided, in accordance with a preferred embodiment of the invention, a method of producing a crystalline material comprising:

juxtaposing a relatively thick layer of crystal powder and a relatively thin layer of crystal powder doped with a photostimulatable dopant; and

pressing the powder to form a transparent polycrystalline material.

In a preferred embodiment of the invention, the crystalline material has the general formula:

AⁱB^{vii}

where Aⁱ is an alkaline metal, B^{vii} is a halogen.

Preferably, the halogen is chosen from the group consisting of fluorine, bromine, chlorine and iodine.

Preferably, the alkali metal is chosen from the group consisting of lithium, sodium, potassium, rubidium, and cesium.

In an alternative preferred embodiment of the invention, the crystalline material has the form:

BaFY:αM,

wherein Y is chosen from the group comprising Cl, Br and I.

In alternative preferred embodiments of the invention, the crystalline material has the form BaF:αM or CaF:αM.

In a preferred embodiment of the invention, the dopant comprises a dopant chosen from the group consisting of Tl⁺, In⁺, Ga⁺, Ag⁺, Cu⁺, Sn⁺⁺, Pb⁺⁺, or Eu⁺⁺.

Preferably, a spatially varying component of the desired profile of dopant is concentrated near the first face. Preferably, the spatially varying component of the dopant concentration falls to half its value at the first face within a distance having a range of 1 to 1000 micrometers. Optionally, the distance is between 150 and 400 micrometers. More preferably the distance is between 200 and 300 micrometers. Alternatively, the distance is between 1 and 150 micrometers.

Preferably, a spatially varying component of the dopant concentration has a value near the surface for the desired profile of between 0.1 to 3 m%. Preferably the surface value is less that 2 m% or 1 m%.

In a preferred embodiment of the invention, the crystalline material has a substantially zero concentration of photostimulatable dopants outside the surface layer. Alternatively, the crystal has a substantially uniform bulk concentration of a photostimulatable dopant outside the surface layer. Preferably, the ratio of the concentration of dopants at the face and in the bulk of the crystal after diffusion is greater than or equal to about 2.

In a preferred embodiment of the invention, the bulk photo-stimulatable dopant is different from that at the surface. Preferably, the various dopant materials emit light of different wavelengths when photostimulated.

In a preferred embodiment of the invention, the crystalline material is a single crystal material. Alternatively, the crystalline material is polycrystalline.

There is further provided, in accordance with a preferred embodiment of the invention, a method of reading out a crystaline material comprising:

a) providing a crystalline material having a surface layer of highly concentrated photo-stimulatable dopant which has been activated by a pattern of ionizable radiation;

b) photo-stimulating the crystalline material; and

c) forming an image of the light emitted from the surface layer.

In a preferred embodiment of the invention, the crystalline material is scanned by a beam and the image is formed from the relationship between the position of the beam and the intensity of the emitted light. In a preferred embodiment of the invention, the beam is sharply focused at the surface layer of the crystal.

In a preferred embodiment of the invention, forming an image comprises forming a separate image of the light produced by the different dopants.

### BRIEF DESCRIPTION OF FIGURES

FIG. 1 shows the spatial distribution of a dopant in a crystal produced by different methods pertaining to prior art, (numeral 10) and to preferred embodiments in accordance with a preferred embodiment of this invention (numerals 14 and 16);

FIG. 2 shows the penetration depth of X rays in three different crystals as a function of the X rays energy;

FIGS. 3A and 3B show spatial distributions of dopants utilized in accordance with a preferred embodiment of this invention; and

FIG. 4 shows a focusing geometry for a laser beam utilized for stimulating a crystal doped in accordance with preferred embodiments of this invention.

### DETAILED DESCRIPTION OF PREFERRED EMBODIMENTS

1. Crystals Utilized

Photo-stimulatable doped crystalline materials suitable for pattern storage, are preferably of the general form X:αM, where X is a crystalline base material, M is a dopant preferably, Tl⁺, In⁺, Ga⁺ Ag⁺ or Cu⁺ or others such as those known in prior art and α represents the concentration of the activator which is preferably kept between 0.1 and 1 m% (approximately 10¹⁸−10¹⁹ ions/cm³). In one especially preferred embodiment of the invention, X is a crystal or polycrystalline material of the form AⁱB^{vii} Aⁱ is an alkaline metal preferably Li, Na, K, Rb, or Cs and B^{vii} is a halogen preferably, F, Br, Cl or I. Alternative base materials are BaFlY, where Y is Cl, Br, or I (generally available only as a transparent polycrystalline material), WO₂ (generally has a low sensitivity), BaF or CaF (available in both grown crystal and pressed polycrystalline forms, with low sensitivity). For some preferred embodiments of the invention dopants as described in a PCT patent application entitled “Methods and Apparatus for recording and reading-Out an ionization radiation Image”, filed on even date with the present application having the same inventor as the present application and U.S. Pat. application Ser. No. 08/726,340 filed Oct. 3, 1996, the disclosures of which are incorporated herein by reference may be used.

Doped crystalline materials intended to be utilized in radiation detectors according to the present invention, have to exhibit such characteristics as to be suitable for:

a) stable electron-hole pairs, which faithfully reproduces a pattern carried by the ionizing radiation, which creates them;

b) faithfully reproducing the stored information during a read out process, for some preferred embodiments of the invention, when such a crystal or polycrystalline material is read out, the stored information is erased. This includes a requirement that the crystalline material be substantially transparent.

Additionally, as some of the materials used in the preparation of crystalline materials for imaging may be damaged when exposed to normal room environment, such materials are preferably protected by a transparent and non scattering thin layer of quartz, ultra-violet glass or polymers such as polycarbonate such as PMMA, ORMOCER, CaF and/or BaF or other suitable protective materials.

2. Doping Profiles

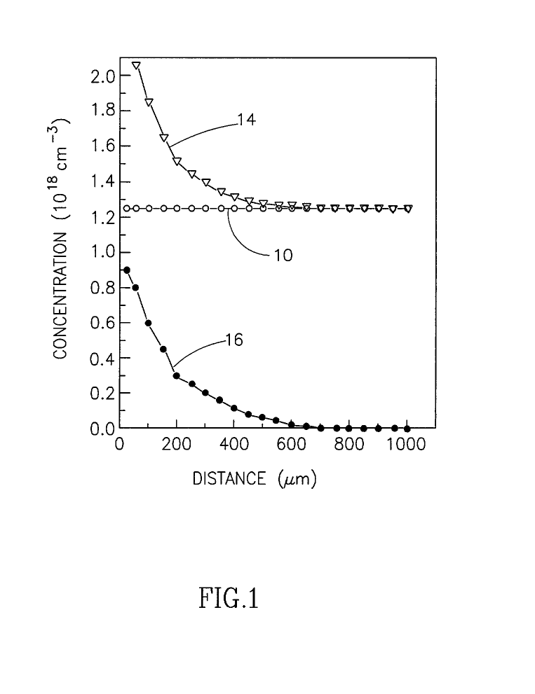

In bulk crystalline materials (as opposed to polycrystalline layers on glass or sapphire or the like) used in the art of imaging by ionizing radiation the dopants are evenly distributed in the volume of the material. It is known that growing a crystal in melt from a mixture of for example an alkali-halide (e.g. KBr) and a dopant (e.g. Indium) will result in a KBr crystal in which the dopant is evenly distributed. The spatial distribution of the dopant as a function of the thickness of such a crystal is represented by curve 10, of FIG. 1. In the known prior art, only relatively thick (thicker than about 2-3 mm) crystals are used for a number of reasons, for example, because of mechanical stability and a desire to achieve good sensitivity. Images acquired with such crystals exhibit relatively poor resolution, of the order of 4-5 lp/mm. A similar situation holds for transparent polycrystalline materials suitable for imaging.

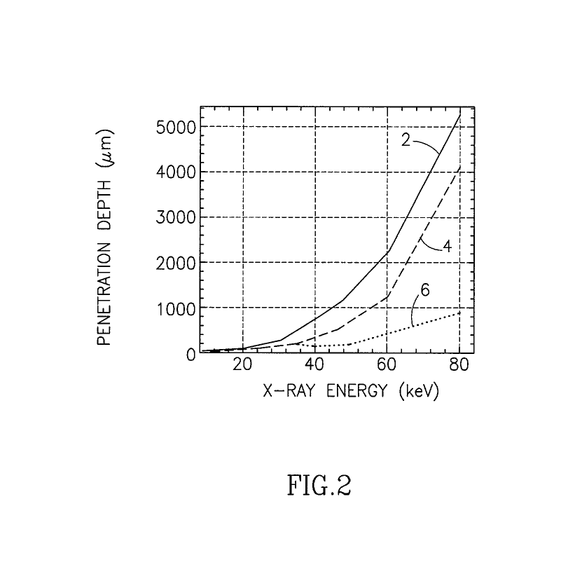

Reference is now made to FIG. 2 which shows the penetration depth of X ray radiation, in three different crystalline materials, as a function of radiation energy. In this figure curve 2 represents BaFBr, curve 4 represents KBr and curve 6 represent KCl. It is seen from this figure that the higher the radiation energy the deeper the radiation penetrates into the material and the thicker it must be in order to obtain, for a given radiation energy, a given number of electron-hole pairs. This illustrates one of the motivations for using crystalline materials that are several mm thick.

When a relatively thin active layer is utilized for obtaining high resolution and/or if the crystal is exposed to a reasonable dose (for humans) of radiation, a relatively low concentration of electron-hole pairs is obtained. As a consequence, only a relatively low sensitivity will be achieved.

In accordance with preferred embodiments of the invention, three types of crystals may be used for different imaging regimes:

a) A crystalline material in which the bulk material has little or no doping an which has a relatively thin layer of doped (e.g., 1-1000 or 100-400 microns) material near one surface. Generally, the dopant is diffused into the bulk material. A typical dopant curve of such a material is shown as curve 16 of FIG. 1.

b) A crystal in which the bulk material is doped with one dopant, which emits light of one wavelength and which has a thin layer of another dopant at a surface of the crystal, which emits light at a different wavelength. For such a crystal, a dopant curve of the bulk is shown as curve 10 of FIG. 1 and a typical dopant curve of the thin layer is shown at curve 16 of FIG. 1. Generally, the dopant of the thin layer is diffused into the bulk material. Such a crystal, as described below, can provide two separate images, a high resolution image and a lower resolution, high sensitivity image.

In an example of such a device, In and Tl are used as dopants in a KBr crystal or transparent polycrystalline base. When photostimulated, Tl will emit in the range of 300-360 nm and In will emit in the range of 400-500 nm.

c) A crystalline material in which the bulk material has a significant doping and which has a thin layer of dopant rich material. Generally, the dopant of the thin layer is diffused into the bulk material. A typical dopant curve for such material is shown at curve 14 of FIG. 1. Such a detector may provide an image similar to those of the prior art, with a boost in the high frequency detection characteristics.

Additionally, a crystal for utilization in imaging according to the present invention may be a single crystal or a pressed crystal which has a polycrystalline structure. However, the highest spatial resolution is apparently achieved by utilizing a single crystal which is substantially free of defects. The above described crystals may also be manufactured by other manufacturing methods.

Various dopant distribution profiles are suitable for different uses. For example, crystalline materials which have only a thin layer of dopant near one of their surfaces are preferably used with low energy X-rays, although they can be used for higher energy X-rays with decreased sensitivity. Lightly volume doped crystalline materials which have a heavily doped layer near one of their surfaces are suitable for use with high energy X-rays, although two wavelength devices are suitable for both high and low energy applications.

According to preferred embodiments of the present invention, when a crystalline which is lightly doped has also a heavily doped layer of the same dopant at one of its surfaces, the concentrations of the dopant are preferably such that, the heavily doped thin layer emits at least between twice and four times as much light as the thick volume doped region when equally irradiated by ionizing radiation and equally stimulated.

The doped crystal is also preferably, substantially transparent to stimulating and fluorescence light, on one hand, and as free as possible of defects for minimally scattering these lights, on the other.

3. Read Out Methods

When a non uniformly doped crystalline is utilized in imaging, the relatively thin region near the face at which the concentration of the dopant is high is read out with high spatial resolution.

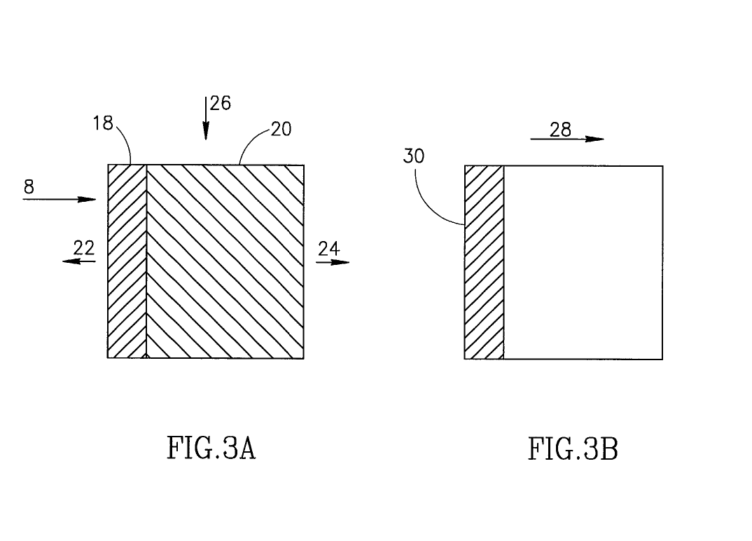

FIGS. 3A and 3B schematically show some of the spatial distributions, described above, of dopants utilized according to the present invention. FIG. 3A shows a crystalline comprising two distinctly doped regions: a heavily doped thin layer 18 and a lightly doped thick layer 20. (It should be understood that while the layers are shown as distinct, the actual concentrations will be those shown in FIG. 1 as described above.) When utilizing a crystalline having such a stepped profile of a dopant's spatial distribution, the ionizing radiation propagating in the direction of arrow 10, inscribes a pattern in the entire volume of the crystalline. The relative number of electron-hole pairs created in volume 18 and in volume 20, depends on the energy of the ionizing radiation. Such a crystal may be photo-stimulated in the directions of arrows 8 or 26 (as described below) and read out in the directions of arrows 22 and/or 24 or from all directions. Alternatively, layers 18 and 20 may contain different dopants.

Because of the presence of a heavily doped thin layer 18, the spatial resolution of the image obtained from such a crystalline will be higher than the spatial resolution of an image obtained when the dopant is evenly distributed.

Where the dopants are different in regions 18 and 20, two separate wavelength images may be achieved, one with high resolution and relatively low sensitivity and one with low resolution, but high sensitivity.

Where only a surface layer of dopant is present, as in 3B, only a high resolution image is acquired. The concentration of the dopant near the surface is made sufficiently high to allow the ionizing radiation create a sufficient number of electron hole pairs for read-out. The read out scheme in this case may be the same as described in the previous case.

When the crystalline is photo-stimulated from direction 26, light is emitted by the entire detector at the same time. This light is preferably collected, from the whole detector, by suitable optical means in the general directions of arrows 22 or 24. Alternatively, images are collected from both sides, aligned, and added, to double the collection efficiency. If two wavelength dopants are used, a two color camera is preferably used, although separate cameras may be used.

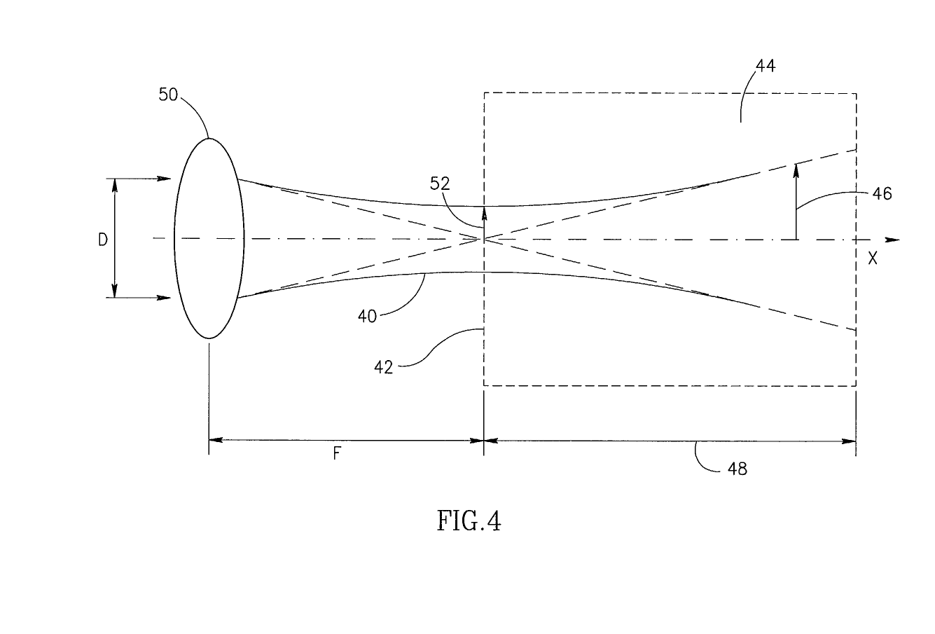

Alternatively, the read out of the crystalline material is performed point by point using a tightly focused laser beam at a suitable wavelength to stimulate the crystalline material. Since the layer is thin, this focused beam will be in focus over substantially the entire layer resulting in very high resolution, reaching 20 lp/mm in some experiments. This may result in some minor loss in resolution in the image from bulk material. FIG. 4 shows a laser beam 40, focused by a lens 50, impinging on surface 42 of a crystal 44.

If the focused laser beam 52, is scanned over surface 30 of a crystal shown in FIG. 3B, each point on this surface will be sequentially stimulated by the laser beam and sequentially read out as a pixel of the image. The advantage of such a read out scheme is the high spatial resolution, which is only limited by the focused laser beam spot diameter. Preferably, light emitted by the crystalline is collected from as large a solid angle as possible and may be detected by several detectors.

In a preferred embodiment of the invention, a 4 mm diameter, 640 nm wavelength laser beam focused by a lens of 200 mm focal length will have a waist ω₀≈20 μm. The spread out of such a laser beam will be of ≈109 μm for a propagation distance of 5 mm but only ≈40 μm for a propagation distance of 100 μm. If a doped crystal with thickness of 100 μm is used according to the present invention, the limit of the resolution allowed by the laser will be a spot of ≈40 μm diameter.

In alternative preferred embodiments of the invention, the laser is not as finely focused at the surface. This may be desirable since it is difficult to keep such a fine focus during sweeping over the surface of the crystal. This would result in somewhat lower, but uniform, resolution.

It will be appreciated by persons skilled in the art that any other laser or non laser stimulation scheme as well as read out schemes than those above described are all within the scope of this invention.

4. Crystal Preparation

The crystalline base material on which the thin layer is formed above may be produced in a number of ways. Single crystal materials are generally produced by growing from a melt of the crystal, optionally containing dopant. Alternatively (optionally doped) crystal powder may be pressed, utilizing methods well known in the art, to form a transparent “slab” of transparent polycrystalline material.

Dopants having the required profile may be introduced in one of three ways. One way is to diffuse the dopant into the crystalline material, in a manner known in the art, as for example from a vapor or a surface layer of the dopant or a salt of the dopant. By controlling the time duration of the diffusion process, various dopant distribution profiles, such as those shown in curves 14 and 16 (or the combination of curves 16 and 10, as described above) in FIG. 1, may be obtained.

A second method of forming a surface layer is to use the well known method of ion implantation.

A third method, which forms a sharp transition between the surface layer and the bulk material is to form both the bulk and surface together during pressing of a polycrystalline Thus, if the bulk material is formed in a mold, a relatively large amount of powder having, for example, no dopant is introduced into the mold. As a preparatory step, this layer may be pressed to bind the powder, without completing the formation of the crystal. Then a small amount of material is added on top of the undoped powder (or the partly formed polycrystalline material) and the pressing step is completed. This results in a thin layer of highly doped material on an undoped or lightly doped base or on a base that is doped with a different dopant than the thin layer, as the case may be, depending on the dopant states of the starting materials.

One way of preparing a doped alkali-halide crystal (e.g. KBr:In) utilized in accordance with the present invention, as described above, is a two step procedure. In this procedure the crystal is first grown in melt from a mixture of the alkali salt, KBr, and a dopant, (for example indium, In), in which the concentration of the dopant in the crystal is preferably about 1.2*10¹⁸ ions/cm³. Alternatively where only a surface layer of dopant is to be present, the crystal is grown dopant free. Alternatively, when a two wavelength detector is to be produced, higher dopant concentrations may be used in the bulk material.

In a second step of the procedure, this crystal is then placed on a quartz ampoule with a powder of InBr₃. The region surrounding the crystal is pumped to 10⁻⁵−10⁻⁶ mm Hg and the crystal is heated to 500° C. preferably for a period of at least 40,000 seconds (about 11 hours). Other diffusion schemes known in the art may also be used.

The typical spatial distribution of the dopant in a crystal prepared as described above is as represented by curve 14 and/or 16 as the case may be, in FIG. 1.

In another way of preparing a doped crystal utilized in accordance with the present invention, a non doped or uniformly doped crystal, KBr, is placed together with a dopant, in powdered metallic or salt (i.e. InBr₃) form, in an evacuated quartz vessel or stainless bomb. The powder of the dopant is placed in a quartz crucible or directly on the surface of the crystal. The vessel is evacuated to 10⁻⁶ mm Hg and the crystal is heated to 500° C., a temperature slightly below the melting point of the crystal for at least 25,000 seconds (about 7 hours). The typical spatial distribution of the dopant (In) in the crystal as a function of the depth the dopant has penetrated the crystal will be as represented by curve 14 or curve 16 (or a combination of curves 16 and 10) of FIG. 1, depending on whether the bulk of the crystal was doped or not.

It should be understood that the exact method utilized for diffusion will depend on the melting and vapor points of the material used to supply the dopant ions.

By varying time duration and temperature, and the starting dopant level (if any) of the bulk material) a variety of dopant profiles may be obtained. Methods of achieving a desired profile (within the limits of available concentrations and limitations on temperature) are well known in the art. For example the temperature can be varied within the range slightly below the melting point of the crystal. The time duration of the doping process (e.g. doping by diffusion) can be set so that it will enable the dopant concentration near the face 28 in FIG. 3B fit the imaging requirements. When preparing crystals wherein the spatial distribution of the dopant may be typically described by curves 14 and/or 16, in FIG. 1, the doping process is stopped before the spatial distribution of the dopant reaches a uniform distribution.

It will be appreciated by a person skilled in the art that the present invention is not limited by what has been described hereinabove. Rather, the scope of the invention is only limited by the following claims.

1. A radiation detector for use in imaging with ionizing radiation, comprising a crystalline detector material having a surface area and a thickness wherein the doping profile in a thickness direction of the crystalline material has the form αM, where M is the dopant and α is doping factor that varies with the thickness direction so as to have at least two non-zero values at at least two distances from the surface.

2. A radiation detector in accordance with claim 1 wherein the crystalline material has the general formula:
AⁱB^{vii}:αm
where Aⁱ is an alkaline metal, B^{vii} is a halogen.

3. A radiation detector in accordance with claim 1 wherein the crystalline material has the form:
BaFY:αM
wherein Y is chosen from the group comprising Cl, Br and I.

4. A radiation detector in accordance with claim 1 wherein the crystalline material has the form XF:αM where X is Ca or Ba and the dopant M is chosen from the group consisting of Tl⁺, In⁺, Ga⁺, Ag⁺, Cu⁺, Sn⁺⁺, Pb⁺⁺, or Eu⁺⁺.

5. A radiation detector in accordance with claim 1, in which the spatially varying component of dopant is concentrated near the surface area.

6. A radiation detector in accordance with to claim 5 wherein the concentration of the spatially varying component of the dopant concentration falls to half the its value at the surface within a distance having a range of 150 to 400 micrometers.

7. A radiation detector in accordance with to claim 5 wherein the concentration of the spatially varying component of the dopant concentration falls to half the its value at the surface within a distance having a range of 1 to 150 micrometers.

8. A radiation detector in accordance with claim 1 wherein a spatially varying component of α has a maximum value in a range from 0.1 to 3 m%.

9. A radiation detector according to claim 1 wherein α has a substantial, non-zero value throughout the crystal.

10. A radiation detector according to claim 1 wherein the ratio of the value of α at the surface of the crystal and within its bulk is greater than or equal to about 2.

11. A radiation detector according to claim 1 α has a non-zero value only near the surface.

12. A radiation detector in accordance with claim 1 wherein the crystalline material is a single crystal material.

13. A radiation detector in accordance with claim 1 wherein the crystalline material is polycrystalline.

14. A radiation detector according to claim 1 wherein the crystal is substantially uniformly doped with a photo-stimulatable dopant different from that having a concentration varying with the thickness direction.

15. A radiation detector according to claim 14 wherein the various dopant materials emit light of different wavelengths when photostimulated.

16. A method for producing an ionizing radiation imaging detector according to claim 1 comprising:
a) providing a crystalline material;
b) implanting a photo-stimulatable dopant into a surface of the crystalline material by ion implantation; and
c) producing an imaging radiation detector from said crystalline material.

17. A method of producing an ionizing radiation imaging detector according to claim 1 comprising:
a) juxtaposing a relatively thick layer of crystal powder and a relatively thin layer of crystal powder doped with a photostimulatable dopant;
b) pressing the powder to form a transparent polycrystalline material; and
c) producing an imaging radiation detector from said crystalline material.

18. A method of reading out a crystalline ionizing radiation imaging detector comprising:
a) providing a crystalline detector having a surface layer of highly concentrated photo-stimulatable dopant and another layer of less concentrated photo-stimulable dopant, both of which have been activated by a pattern of ionizing radiation;
b) photo-stimulating the crystalline detector; and
c) forming an image at least of light emitted from the surface layer light emitted by the other layer.

19. A method according to claim 18 wherein the crystalline detector is scanned by a beam and the image is formed from the relationship between the position of the beam and the intensity of the emitted light.

20. A method according to claim 18 wherein the beam is sharply focused at the surface layer of the crystalline detector.

21. A method according to claim 18 wherein forming an image comprises forming a separate image of the light produced by the different dopants.
